(19) United States
(12) Patent Application Publication
(10) Pub. No.: US 2024/0059291 A1
(43) Pub. Date: Feb. 22, 2024

(54) VEHICLE ANTI-PITCH OPERATIONS DURING NEAR STOPPED STATE CONDITIONS

(71) Applicant: GM Global Technology Operations LLC, Detroit, MI (US)

(72) Inventors: Brian K. SAYLOR, South Lyon, MI (US); Edward T. HEIL, Howell, MI (US)

(21) Appl. No.: 17/890,599

(22) Filed: Aug. 18, 2022

(51) Int. Cl. B60W 30/18; B60W 40/11

(52) U.S. Cl. CPC B60W 30/18109; B60W 40/11; B60W 2510/182

(57) ABSTRACT

A brake torque control system of a host vehicle includes a memory and a brake torque control module. The memory stores, for a braking event, multiple values indicative of whether an object has been detected forward of the host vehicle, a speed of the host vehicle, and an expected stopping distance or an expected stopping location of the host vehicle. The brake control module, based on the values, operates in an anti-pitch mode and reduces at least one of an amount of brake torque requested and a brake pressure applied for a last remaining portion of the braking event to reduce pitch of the host vehicle prior to coming to a complete stop and to not reduce the at least one of the amount of brake torque requested and the brake pressure applied for a portion of the braking event prior to the last remaining portion of the braking event.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle braking systems, and more particularly to vehicle anti-pitch control systems.

Vehicles can include deceleration control systems, object detection systems, collision avoidance systems, adaptive cruise control systems, forward collision warning systems, and autonomous vehicle control systems controlling vehicle operations including accelerating and decelerating the vehicle, detecting objects, and taking actions to avoid a collision. For example, an adaptive cruise control system may adjust speed of a host vehicle to prevent collision with another vehicle in front of the host vehicle. As another example, a collision avoidance system may detect an oncoming vehicle and take an evasive action and/or perform a countermeasure to avoid colliding with the approaching vehicle. The actions performed may include steering and/or braking operations.

### SUMMARY

A brake torque control system of a host vehicle is disclosed. The brake torque control system includes a memory and a brake torque control module. The memory is configured to store, for a braking event, multiple values indicative respectively of whether an object has been detected forward of the host vehicle, a speed of the host vehicle, and at least one of an expected stopping distance and an expected stopping location of the host vehicle. The brake control module is configured to, based on the values, operate in an anti-pitch mode and reduce at least one of an amount of brake torque requested and a brake pressure applied for a last remaining portion of the braking event to reduce pitch of the host vehicle prior to coming to a complete stop and to not reduce the at least one of the amount of brake torque requested and the brake pressure applied for a portion of the braking event prior to the last remaining portion of the braking event.

In other features, the brake control module is configured to reduce the at least one of the amount of brake torque requested and the brake pressure applied for a last predetermined distance of the braking event. The last predetermined distance is less than or equal to 2 meters.

In other features, the brake control module is configured to limit an amount of increased braking distance due to the reduction in the at least one of the amount of brake torque requested and the brake pressure applied. The amount of increased braking distance is limited to 0.2 meters.

In other features, the brake torque control system further includes: an object detection sensor configured to detect one or more objects forward of the host vehicle and generate an object detection signal indicative of a detected one or more objects forward of the host vehicle. The brake control module is configured to adjust an amount of the reduction in the at least one of the amount of brake torque requested and the brake pressure applied based on distances and speeds of the one or more objects relative to the host vehicle.

In other features, the brake control module is configured to disable the anti-pitch mode based on at least one of proximity and speed of an object relative to the host vehicle.

In other features, the brake torque control system further includes a speed sensor configured to detect the speed of the host vehicle. The brake control module is configured to enable the anti-pitch mode when the speed is greater than a set threshold.

In other features, the brake torque control system further includes a brake actuator sensor configured to detect whether brakes of the host vehicle are being applied. The brake control module is configured to disable the anti-pitch mode when the brakes are not applied.

In other features, the brake control module is configured to adjust the amount of brake torque requested based on: the expected stopping distance; the speed of the host vehicle; and a predetermined distance from when brake torque reduction is to begin to when the host vehicle is stopped.

In other features, the brake control module is configured to: adjust the amount of brake torque requested based on a set effect level, the set effect level is preselected and ranges between 0 and 1; multiply an amount of brake torque reduction by the set effect level to provide a resultant value; and subtract the resultant value from the amount of brake torque requested to provide a resultant amount of brake torque requested

In other features, the brake control module is configured to, based on the values, reduce a magnitude, adjust a duration and adjust a reduction rate of change in the at least one of the brake torque requested and the brake pressure applied.

In other features, the brake control module is configured to, based on the values and at least one of distance and speed of a detected object relative to the host vehicle, reduce a magnitude of the brake pressure, adjust a reduction rate of change in brake pressure, and adjust a reduction rate of change of the brake pressure based on.

In other features, a brake torque control method is disclosed and includes: storing, for a braking event, multiple values indicative respectively of whether an object has been detected forward of a host vehicle, a speed of the host vehicle, and at least one of an expected stopping distance and an expected stopping location of the host vehicle; based on the values, operating in an anti-pitch mode and reducing at least one of an amount of brake torque requested and a brake pressure applied for a last remaining portion of the braking event to reduce pitch of the host vehicle prior to coming to a complete stop; and refraining from reducing the at least one of the amount of brake torque requested and the brake pressure applied for a portion of the braking event prior to the last remaining portion of the braking event.

In other features, the brake torque control method further includes: detecting one or more objects forward of the host vehicle and generating an object detection signal indicative of a detected one or more objects forward of the host vehicle; and adjusting an amount of the reduction in the at least one of the amount of brake torque requested and the brake pressure applied based on distances and speeds of the one or more objects relative to the host vehicle.

In other features, the brake torque control method further includes disabling the anti-pitch mode based on at least one of proximity and speed of an object relative to the host vehicle.

In other features, the brake torque control method further includes: detecting the speed of the host vehicle; and enabling the anti-pitch mode when the speed is greater than a set threshold.

In other features, the brake torque control method further includes: detecting whether brakes of the host vehicle are being applied; and disabling the anti-pitch mode when the brakes are not applied.

In other features, the brake torque control method further includes adjusting the amount of brake torque requested based on: the expected stopping distance; the speed of the host vehicle; and a predetermined distance from when brake torque reduction is to begin to when the host vehicle is stopped.

In other features, the brake torque control method further includes: adjusting the amount of brake torque requested based on a set effect level, the set effect level is preselected and ranges between 0 and 1; multiplying an amount of brake torque reduction by the set effect level to provide a resultant value; and subtracting the resultant value from the amount of brake torque requested to provide a resultant amount of brake torque requested.

In other features, the brake torque control method further includes, based on the values, reducing at least one of a magnitude, a duration and a reduction rate of change in the brake torque requested.

In other features, the brake torque control method further includes, based on the values and at least one of distance and speed of a detected object relative to the host vehicle, reducing a magnitude of the brake pressure and adjusting a reduction rate of change of the brake pressure.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram illustrating change in pitch due to a vehicle decelerating to a stop state due to braking;

FIG. 2 is a functional block diagram of a vehicle including a brake torque control system including a brake torque module implementing anti-pitch operations in accordance with the present disclosure;

FIG. 3 is a comparison diagram illustrating differences in vehicle pitch when approaching a stopped location due to differences in brake torque requested and whether an anti-pitch mode is enabled in accordance with the present disclosure;

FIG. 4 is a comparison diagram illustrating differences in pitch and stopping distance between when the anti-pitch mode is not enabled versus when the anti-pitch mode is enabled in accordance with the present disclosure;

FIG. 5 is a diagram illustrating reduced brake torque request for last portion of braking event and corresponding reduced pitch angle prior to stopping in accordance with present disclosure;

FIG. 6 illustrates an anti-pitch method in accordance with the present disclosure;

FIG. 7 is a plot of brake torque requested versus distance illustrating reduced brake torque for a last period of a braking event in accordance with present disclosure; and

FIG. 8 is a plot of adjusted brake torque requested versus estimated distance to stop illustrating different brake torque reduction modes and corresponding percentages of brake torque reduction in accordance with the present disclosure.

In the drawings, reference numbers may be reused to identify similar and/or identical elements.

### DETAILED DESCRIPTION

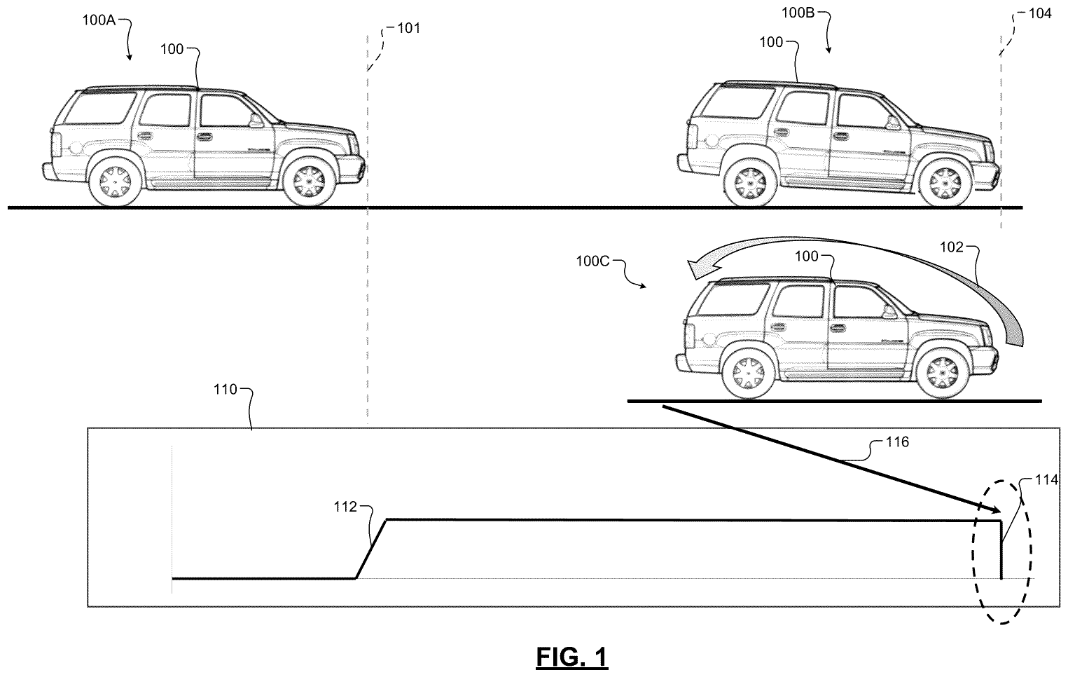

When a vehicle is decelerated by braking from a speed greater than, for example, 10 kilometers per hour (kph), the vehicle tends to pitch downward in the front. The vehicle can have significant pitch due to the braking deceleration of the vehicle. This can be referred to as a “nose dive” while braking. When the vehicle comes to a stop (i.e., has zero velocity), the vehicle can abruptly pitch back to an at rest state. FIG. 1 illustrates this change in pitch. In FIG. 1, a vehicle 100 is shown when beginning to brake, designated 100A. The braking start point is indicated by dashed line 101. The vehicle 100 is then shown when at a stop point, prior to pitching back to the at rest state, designated 100B. The vehicle is then shown in the at rest state and not being pitched downward in the front, designated 100C. The rock back to the at rest state is indicated by arrow 102 and the stopped point is indicated by dashed line 104. There is no change in displacement when rocked back to the at rest state. A plot 110 of vehicle body pitch versus distance is shown in relationship to the vehicle states designated by 100A, 100B and 100C. The signal plot 110 illustrates an increase in body pitch at the beginning of braking, designated by line segment 112, and the abrupt decrease in body pitch at the end of deceleration when the vehicle is stopped, designated by line segment 114. The line segment 114 corresponds with the at rest state, designated by arrow 116.

The described pitch that occurs during braking and the abrupt decrease in pitch at the end of deceleration when the vehicle comes to rest can cause user discomfort. The amount of body pitch during braking and the abrupt decrease in body pitch when stopped may be decreased by stiffening a suspension of the vehicle. However, this would also degrade ride comfort when traveling over bumpy roads.

As used herein, a “braking event” refers to when brakes are applied and continually applied (i.e., brake pressure to decelerate host vehicle is maintained) until the host vehicle comes to a stop. A braking event does not refer to when brakes are applied and released prior to the host vehicle coming to a stop.

The examples set forth herein include reducing brake pressure near an end of deceleration when a vehicle is within a set distance (e.g., less than 2 meters) of being stopped. This is accomplished without requiring the stiffening of a vehicle suspension. The set distance may be referred to as the set anti-pitch distance or last set distance. The examples include reducing brake pressure when objects are not detected forward of and within a predetermined range of an expected stopped location of the vehicle. The magnitude and/or duration of reduction may be predetermined, variable, and/or adjusted based on vehicle size, weight, speed (or velocity), expected distance to stop, brake torque requested, brake pressure, and/or other vehicle parameter, such as a set effect level of anti-pitch application, as further described below. The disclosed examples reduces and/or eliminates the uncomfortable rate of pitch correction when a vehicle comes to a stop by reducing brake pressure at low velocity. Although the stopping distance is slightly increased by, for example, (0.1-0.2 meters), the increased stopping distance is minimal. Also, the reduction in brake pressure is implemented when increased stopping distance is available, such as when there are no nearby objects forward of vehicle, and thus it is safe to extend the stopping distance by this amount.

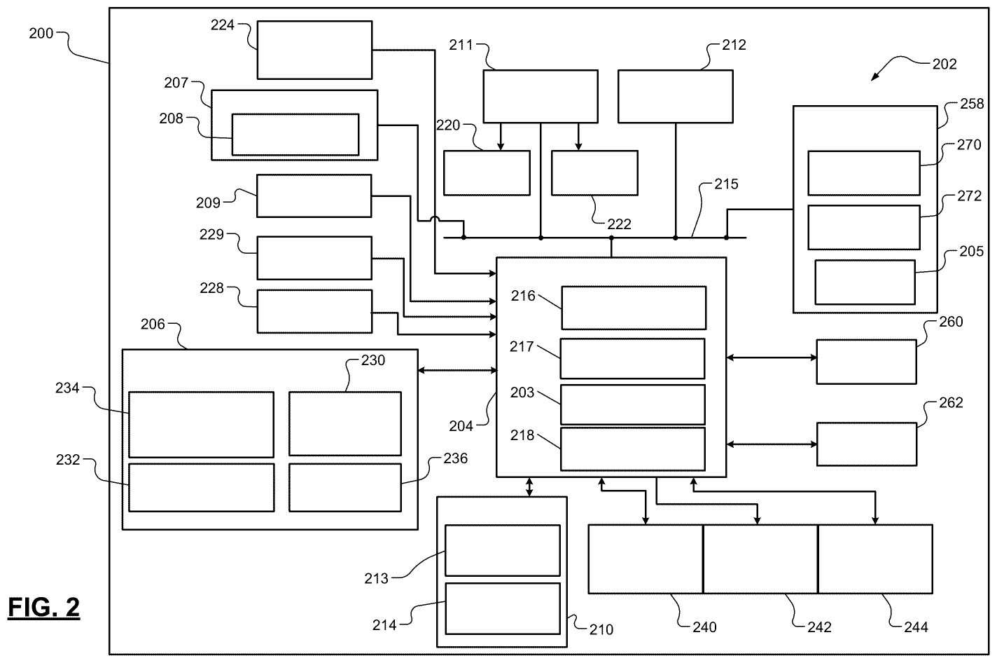

FIG. 2 shows a vehicle 200 including a brake torque control system 202 including a brake torque module 203 implementing anti-pitch operations as described herein. Although the brake torque module 203 is shown as being implemented at a vehicle control module 204, the brake torque module 203 may be implemented at an electronic braking control module (EBCM) 205. The brake torque module 203 and/or the EBCM 205 control an amount of brake torque provided and brake pressure applied, which are directly related. The brake torque module 203 and the EBCM 205 may each be referred to as a brake control module and may be used to reduce brake torque requested and brake pressure during a last set period and/or set anti-pitch distance (e.g., less than or equal to 2 meters) of a braking event. The last set period may be determined based on the set anti-pitch distance and vehicle parameters, such as vehicle size, vehicle weight, vehicle speed (or velocity), brake torque requested, and/or brake pressure. The set anti-pitch distance may be, for example, 1-2 meters (m). The set anti-pitch distance and set period for anti-pitch operations are determined independent of relative distances and speeds of detected objects, when the anti-pitch operations may be performed when objects may be well outside a stopping distance of the host vehicle 200.

In one embodiment, the brake torque module 203 and/or the EBCM 205, may increase (or boost) brake pressure earlier in a braking event prior to the last set period and/or prior to being within the last set distance. This boosted brake pressure may be provided such that the stopping distance of the vehicle 200 is not increased due to the anti-pitch operations in the last set period and/or last set distance of the braking event. The boosted brake pressure compensates for the decreased brake pressure during the last set distance. The anti-pitch operations including reducing brake pressure to decrease pitching of the vehicle during the last set period and/or last set distance (or range). The boosted brake pressure may be spread over the braking event up until performing the anti-pitch operations to minimize the amount of boosted pressure at any moment in time, such that the driver of the vehicle is less likely to notice the increased pressure.

The vehicle 200 may be a non-autonomous, partially autonomous or fully autonomous vehicle. The vehicle 200 may be non-electric, hybrid or fully electric vehicle. The vehicle 200 includes vehicle control module 204, a memory 206, a vision sensing (or perception) system 207 including object detection sensors 208, and other sensors 209. The vehicle 200 may further include a power source 210, an infotainment module 211 and other control modules 212. The power source 210 includes one or more battery packs (one battery pack 213 is shown) and a control circuit 214. The object detection sensors 208 may include cameras, radar sensors, lidar sensors, and/or other object detection sensors. At least some of the object detection sensors 208 may be located on the vehicle 200 to detect objects forward of the vehicle.

The other sensors 209 may include temperature sensors, accelerometers, a vehicle velocity sensor, and/or other sensors. The modules 204, 205, 211, 212 may communicate with each other and have access to the memory 206 via one or more buses and/or network interfaces 215. The network interfaces 215 may include a controller area network (CAN) bus, a local interconnect network (LIN) bus, an auto network communication protocol bus, and/or other network bus.

The vehicle control module 204 controls operation of vehicle systems. The vehicle control module 204 may include the brake torque module 203, a mode selection module 216, a parameter adjustment module 217, an object detection module 218, as well as other modules. The mode selection module 216 may select a vehicle operating mode. The parameter adjustment module 217 may be used to adjust obtain and/or determine parameters of the vehicle 200 based on, for example, signals from the sensors 208, 209 and/or other devices and modules referred to herein.

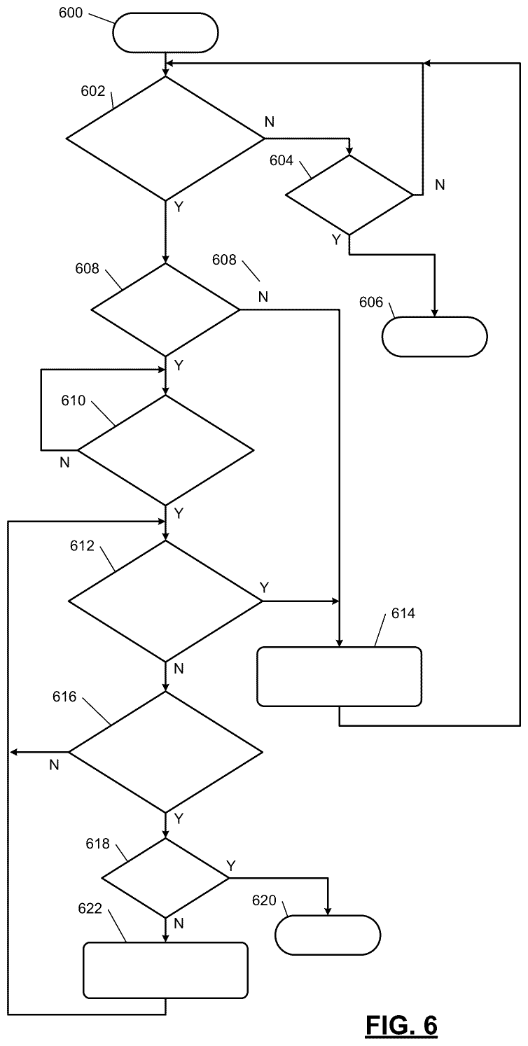

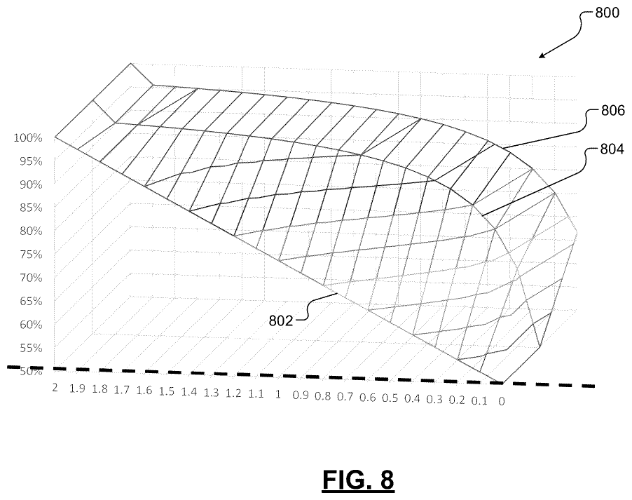

The vehicle 200 may further include a display 220, an audio system 222, and one or more transceivers 224. The display 220 and/or audio system 222 may be implemented along with the infotainment module 211 as part of an infotainment system. The display 220 and/or other interface may be used to set an effect level of anti-pitch application. The anti-pitch mode may be off, fully on, or set at a variable effect level therebetween. This allows a user to set how much brake torque and brake pressure is reduced during the last set period of a braking event and when the vehicle 200 is in a last set distance of being stopped, as further described below with respect to FIGS. 6 and 8. The display may be used to set the anti-pitch distance (e.g., 1-2 m) over which brake torque requested is reduced when anti-pitch mode is enabled. The anti-pitch distance is thus a calibratable distance. The display 220 and/or audio system 222 may also be used to indicate brake alert and/or status messages. A message may be generated indicating: when anti-pitch mode is enabled; when brake torque and pressure is being reduced; when to apply brakes due to an approaching and/or nearing object; etc.

The vehicle 200 may further include a global positioning system (GPS) receiver 228 and a MAP module 229. The GPS receiver 228 may provide vehicle velocity and/or direction (or heading) of the vehicle and/or global clock timing information. The GPS receiver 228 may also provide vehicle location information. The MAP module 229 provides map information. The map information may include traffic control objects, routes being traveled, and/or routes to be traveled between starting locations (or origins) and destinations. The vision sensing system 207, the GPS receiver 228 and/or the MAP module 229 may be used to determine location of objects and position of the host vehicle 200 relative to the objects. This information may also be used to determine i) heading information of the host vehicle 200 and/or the objects, and ii) speeds and distances of the host vehicle 200 relative to the objects.

The memory 206 may store sensor data 230, vehicle parameters 232, an anti-pitch application 234 and other applications 236. The anti-pitch application 234 may be implemented by the brake torque module 203 and/or the EBCM 205. The applications 236 may include applications executed by the modules 204, 211, 212. Although the memory 206 and the vehicle control module 204 are shown as separate devices, the memory 206 and the vehicle control module 204 may be implemented as a single device. The memory 206 may be accessible to the EBCM 205. The EBCM 205 may also include memory storing the anti-pitch application 234 and/or brake information, such as brake pressure or force versus brake actuator distance profiles. The brake pressure or force versus brake actuator distance profiles may be stored in the memory 206.

The vehicle control module 204 may control operation of an engine 240, a converter/generator 242, a transmission 244, a brake control system 258, electric motors 260 and/or a steering system 262 according to parameters set by the modules 203, 204, 205, 211, 212, 218. The vehicle control module 204 may set some of the vehicle parameters 232 based on signals received from the sensors 208, 209. The vehicle control module 204 may receive power from the power source 210, which may be provided to the engine 240, the converter/generator 242, the transmission 244, the brake control system 258, the electric motors 260 and/or the steering system 262, etc. Some of the vehicle control operations may include enabling fuel and spark of the engine 240, starting and running the electric motors 260, powering any of the systems 202, 258, 262, and/or performing other operations as are further described herein.

The engine 240, the converter/generator 242, the transmission 244, the brake control system 258, the electric motors 260 and/or the steering system 262 may include actuators controlled by the vehicle control module 204 to, for example, adjust fuel, spark, air flow, steering wheel angle, throttle position, pedal position, etc. This control may be based on the outputs of the sensors 208, 209, the GPS receiver 228, the MAP module 229 and the above-stated data and information stored in the memory 206.

The brake control system 258 may be implemented as a brake-by-wire system and/or electronic brake boost system. In an embodiment, the brake control system 258 may include the EBCM 205, a brake actuator 270 and a brake actuator sensor 272. The brake actuator 270 may include a traditional style brake pedal and/or other brake actuator, such as a handheld brake actuator. The brake actuator sensor 272 detects position of the brake actuator 270, which is used to determine displacement of the brake actuator 270. The EBCM 205 may include a motor and an electronic control module for controlling operation of the motor. The motor may adjust brake pressure. The brake pressure may refer to pressure of a hydraulic fluid used to actuate brake pads.

The vehicle control module 204 may determine various parameters including a vehicle speed, an engine speed, an engine torque, a gear state, an accelerometer position, a brake pedal position, an amount of regenerative (charge) power, and/or other information.

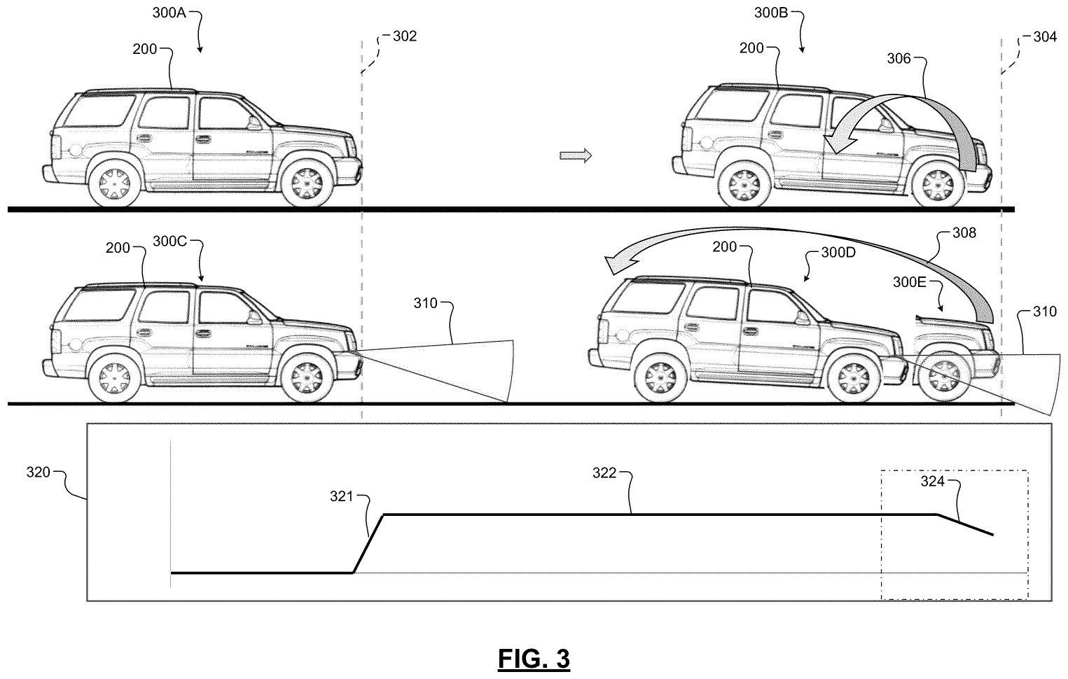

FIG. 3 shows a comparison diagram illustrating differences in vehicle pitch when approaching a stopped location due to differences in brake torque requested and whether an anti-pitch mode is enabled. The vehicle 200 is shown when anti-pitch mode is disabled and braking begins, designated as 300A, and just before braking ends, designated as 300B. Dashed line 302 is indicative of when braking begins and dashed line 304 is indicative of when the vehicle comes to a stop. Pitch of the vehicle 200 returning to an at rest state is designated as 306. The vehicle 200 is not shown in the at rest state in FIG. 3 for the example when the anti-pitch mode is disabled.

FIG. 3 further shows the vehicle 200 when the anti-pitch mode is enabled. The vehicle 200 or a front portion thereof is shown: at the beginning of braking, designated 300C; and when the vehicle 200 is in the last set distance prior to being stopped, designated 300D; and when the vehicle 200 is stopped, designated 300E. During the braking event, the object detection sensors 208 and/or vision system 207 of FIG. 2 are used to detect objects forward of the vehicle 200. This is represented by sensing pattern 310. When objects are not detected and/or outside of a predicted stopping range of the vehicle 200, the anti-pitch mode is enabled. This may change during the braking event when an object enters the path of the vehicle 200 and is within a predetermined range of the expected stopping location of the vehicle 200. The object may be between the vehicle 200 and the stopping location and/or outside the stopping range of the vehicle 200 by less than a predetermined distance when the anti-pitch mode is disabled.

The anti-pitch mode operations to reduce the brake torque and brake pressure may begin, for example, when the vehicle 200 is within the set last distance (e.g., 1-2 m) from the stopped location. This reduces the pitch of the vehicle 200 prior to stopping such that there is not an abrupt change in pitch when the vehicle 200 stops. The pitch back (or pitch relax back) of the vehicle 200 during the set last distance while operating in the anti-pitch mode is thus longer than the pitch back when the anti-pitch mode is disabled, which occurs at the stopped location. The pitch back while operating in the anti-pitch mode is represented by arrow 308.

A plot 320 is shown illustrating brake torque requested. The brake torque is increased and the beginning of braking is designated by line segment 321. The brake torque requested is decreased prior to the end of braking, designated by line segment 324. The brake torque requested may be held constant between the brake torque increasing period associated with the line segment 321 and the brake torque decreasing period associated with the line segment 324. This is designated by line segment 322. The distance traveled while the brake torque requested is decreased may be referred to as a “controlled rock distance”. The pitch (or vehicle rocking) is controlled during the last anti-pitch distance until the vehicle 200 is at a zero speed (or stopped) state. The brake torque requested throughout a braking event may be based on the position of a brake actuator (e.g., brake pedal) of the corresponding vehicle and the amount of brake torque reduction due to enablement of the anti-pitch mode.

The brake torque requested and brake pressure are directly related and are reduced when the vehicle 200 is in a low velocity state. This occurs after the vehicle 200 has been braking for a period of time and the vehicle 200 is at or approaching the last set distance of the braking period.

As an example and referring to FIG. 2, the amount of brake torque may be requested by the brake torque module 203 and provided to the EBCM 205. As an example, the brake torque module 203 may determine an amount of brake torque based on the position of the brake actuator and, when the anti-pitch mode is enabled and during the last set period and/or last set distance of the braking event, subtract a determined amount of brake torque to provide a resultant amount of brake torque requested. The brake torque module 203 may increase and/or ramp up the amount of reduction the closer the vehicle gets to the expected stopped location.

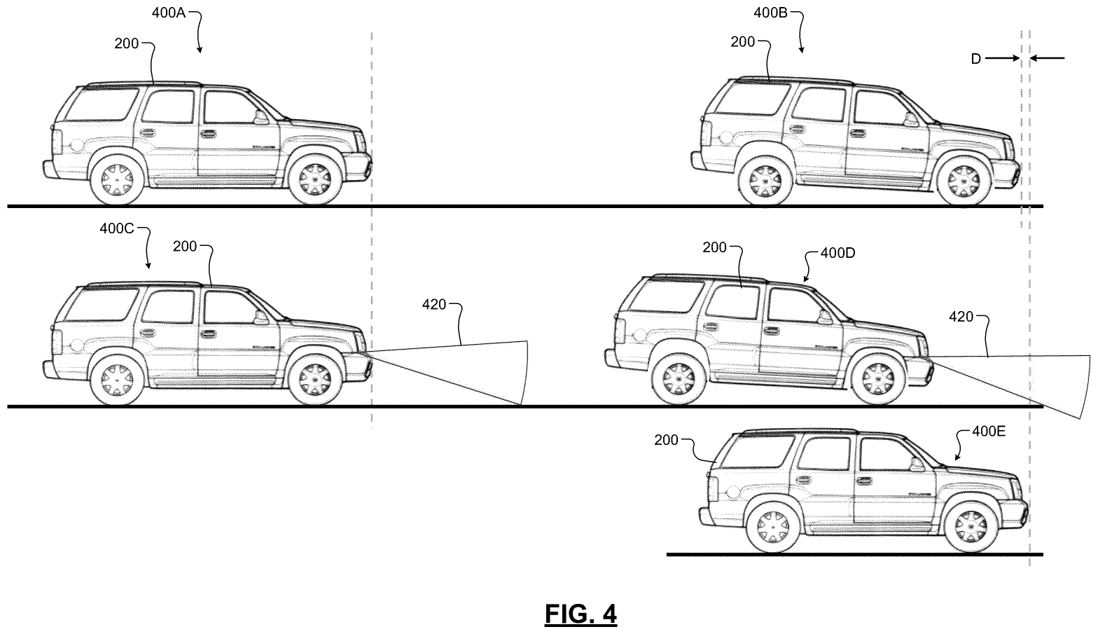

FIG. 4 shows a comparison diagram illustrating differences in pitch and stopping distance between when the anti-pitch mode is not enabled versus when the anti-pitch mode is enabled. The vehicle 200 is shown when the anti-pitch mode is disabled at the beginning of braking, designated as 400A, and near the end of braking prior to coming to a complete stop and pitching back, designated as 400B. The vehicle 200 is also shown when the anti-pitch mode is enabled at the beginning of braking, designated as 400C, and prior to reaching the anti-pitch range (or last set distance), designated as 400D. The increased distance D that may occur due to operating in the anti-pitch mode and reducing the amount of requested brake torque is shown. As an example, the increased distance may be 0.1-0.2 m or less than or equal to 0.2 m. In an embodiment, the increased distance is limited to be 0.1-0.2 m or less than or equal to 0.2 m. The distance D is minimal and may be reduced and/or non-existent depending on how much brake torque requested and brake pressure are reduced, the manner in which the brake torque requested and pressure are reduced over time, and/or whether brake torque requested and brake pressure are boosted prior to the vehicle reaching the beginning of the anti-pitch range.

During the braking event, the object detection sensors 208 and/or vision system 207 are used to detect objects forward of the vehicle 200. This is represented by sensing pattern 420. The vehicle 200 is also shown in the at rest state, designated as 400E.

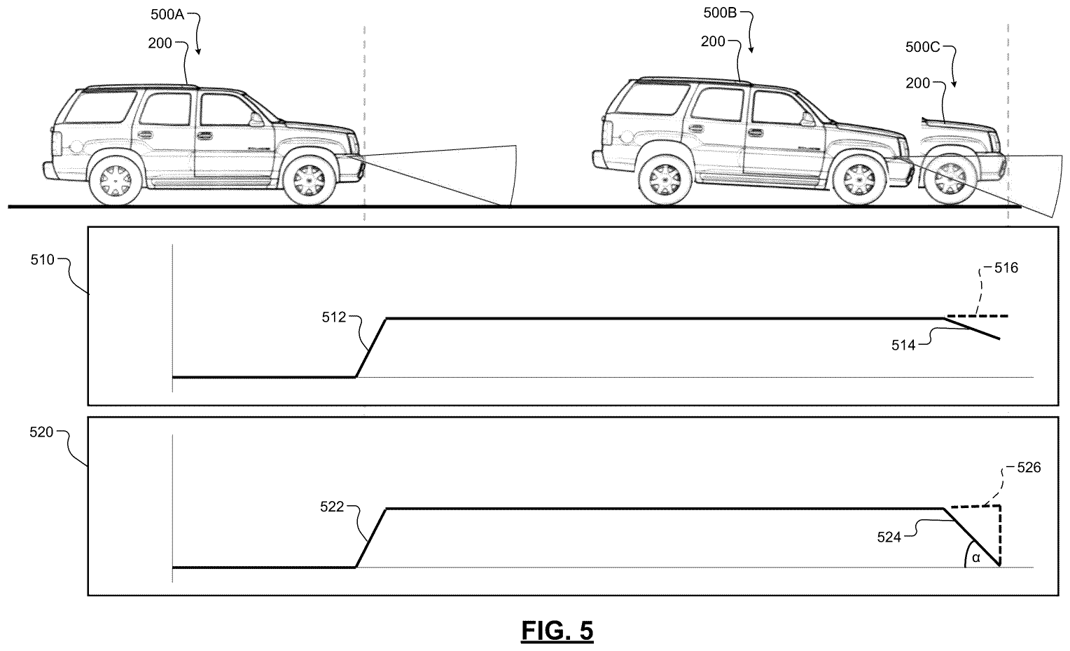

FIG. 5 shows a diagram illustrating reduced brake torque request for last portion of braking event and corresponding reduced pitch angle prior to stopping. The vehicle 200 or a portion thereof is shown: at the beginning of braking, designated as 500A; prior to reaching the anti-pitch range, designated as 500B; and when in an at rest state, designated as 500C.

A brake torque rested versus distance plot 510 is shown illustrating a ramp up in brake torque requested at the beginning of braking and a ramp down in brake torque requested, which begins prior to the vehicle 200 coming to a stop. The ramp up in brake torque requested is shown by line segment 512 and the ramp down in brake torque requested is shown by line segment 514. A dashed line segment 516 is shown and represents if the brake torque requested is not decreased.

A vehicle body pitch versus distance plot 520 is shown illustrating a ramp up in vehicle body pitch at the beginning of braking and a ramp down in vehicle body pitch, which begins prior to the vehicle 200 coming to a stop. The ramp up in vehicle body pitch is shown by line segment 522 and the ramp down in vehicle body pitch is shown by line segment 524. A dashed line segment 526 is shown and represents if the brake torque requested is not decreased. The line segment 524 has a reduced angle α relative to the horizontal axis as compared to the vertical portion of the line segment 526 and illustrates vehicle pitch being controlled to reduce the angle α.

In one embodiment, radar sensors are used to detect objects forward of the vehicle 200. This is done to determine if there are objects forward of the vehicle 200 and whether the objects: are within a predetermined range of the vehicle 200; are within an expected stopping range of the vehicle 200; are less than a predetermined distance (e.g., 3-20 m) from an expected stopping location of the vehicle 200; and/or are outside the expected stopping range by less than the predetermined distance (e.g., 3-20 m). In one embodiment, the predetermined distance is 4 m. The expected stopping range and/or expected stopping distance may be calculated based on the size, weight, speed, brake torque requested, brake pressure applied, etc. Distances and locations of the detected objects relative to the vehicle 200 may be determined. If an object is not within the expected stopping range, is greater than the predetermined distance from an expected stopping location of the vehicle 200, and/or is outside the expected stopping range by more than a predetermined distance, then the anti-pitch mode is enabled. The brake torque requested is reduced when the anti-pitch mode is enabled and the vehicle 200 is in the anti-pitch range of the expected stopped location. The brake torque requested is reduced near the end of a braking distance, which allows the vehicle 200 to pitch back to being near or in an at rest state prior to being fully stopped. If an object is detected forward of the vehicle and the object is determined to be too close to the vehicle 200, then the brake torque requested is not reduced.

FIG. 6 shows an anti-pitch method. The operations may be performed by the brake torque module 203 and/or the EBCM 205 of FIG. 2 and may be iteratively performed. The method may begin at 600. At 602, one or more brake control modules (e.g., the brake torque module 203 and/or the EBCM 205) determines whether brakes have been applied (e.g., brake actuator 270 has been actuated or pressed) to decelerate the vehicle 200 and whether the speed of the vehicle 200 is greater than a predetermined speed (e.g., 10 kph). If no, operation 604 may be performed, otherwise operation 608 may be performed.

At 604, the one or more brake control modules determines whether the vehicle 200 has come to a stop. If yes, the method may end at 606, otherwise operation 602 may be performed.

At 608, the one or more brake control modules determines whether the anti-pitch mode is ON. When the set effect level for anti-pitch operation is not OFF, then the anti-pitch mode is ON and partially or fully in effect. The anti-pitch mode may thus be user enabled. If yes operation 610 is performed, otherwise operation 614 may be performed.

At 610, the one or more brake control modules determines whether brakes are applied and vehicle speed is decreasing. If yes, operation 612 is performed.

At 612, the one or more brake control modules determines whether an object is detected forward of the vehicle 200 and is within distance of concern, as described above. Object detection sensors are used to detect relative locations of objects to ensure that an upcoming reduction in requested brake torque is safe and the vehicle 200 remains outside of a range of a potential collision due to an increased braking distance when applicable. If yes, operation 614 may be performed, otherwise operation 616 may be performed.

At 614, the one or more brake control modules refrain from reducing the amount of brake torque requested for anti-pitch purposes, such as during the last portion of the braking event.

At 616, the one or more brake control modules determines whether the expected distance to stop the vehicle 200 from a current location of the vehicle 200 is less than or equal to the anti-pitch distance. The expected distance to stop and the expected stopping location may be based on the vehicle weight, vehicle speed, brake torque requested, brake pressure, etc. The anti-pitch distance may be fixed and/or set based on vehicle speed and/or expected stopping distance of the vehicle 200. If yes operation 618 is performed, otherwise operation 612 may be performed as shown or one of operations 602 and 610 may be performed.

At 618, the one or more brake control modules determines whether the vehicle 200 has stopped. If yes, the method may end at 620, otherwise operation 622 may be performed.

At 622, the one or more brake control modules operate in the anti-pitch mode and perform anti-pitch operations to reduce the brake torque requested and reduce an amount of pitch of the vehicle 200. The reduction in brake torque requested may be implemented as disclosed herein. The brake torque reduction occurs when the vehicle 200 is near the end of the braking event and speed (or velocity) of the vehicle 200 is low (e.g., less than 5-10 kph). This is done to improve occupant comfort by reducing the gradient of vehicle pitch.

The magnitude, duration and rate of the amount of reduction in brake torque requested and/or the magnitude, duration and rate of the amount of reduction in brake pressure during the last portion of the braking event may be determined based on: relative locations, distances and speeds of detected objects; and/or size, weight, speed, and/or deceleration rate of the vehicle 200. The magnitudes, durations and rates of reduction in brake torque requested and brake pressure may be based on a calibratable (or selectable) distance from when reduced braking begins to when the vehicle is stopped. The calibratable distance may be set based on size, geometry, and center of gravity (CG) of the vehicle 200. A vehicle with a high CG may have a higher calibrated distance than a vehicle with a lower CG. For example, the distance may be 2 m for a sport utility vehicle or truck and may be 1 m for a sports car. The calibratable distance may also be based on longitudinal acceleration (or deceleration) and speed of the vehicle.

The anti-pitch mode may be disabled and/or the effect level may be set to 0 (or OFF) if objects forward of the vehicle satisfy the above-stated criteria to be of concern. The more the magnitude and duration of brake torque reduction are reduced, the closer the objects are to the vehicle 200 and/or the quicker the distances between the vehicle 200 and the objects are decreasing.

Variable control may be implemented to select a set effect level of anti-pitch application. The set effect level may be one of multiple different possible levels including an OFF, low, medium and high effect level. The set effect level of anti-pitch application may be selected by a finite number of settings or may be variable and set at and/or between a minimum (e.g., 0%) and a maximum effect level (e.g., 100%). The minimum and maximum effect levels may be implemented by multiplying, for example, a brake pressure reduction value by a scalar value between 0-1, where 0 is OFF, a value of 0 or near 0 may be considered low, a value between 0 and 1 refers to a partially ON state, a value near 0.5 is medium, a value of 1 or near 1 is high, and a value of 1 is fully ON. A user may adjust the set effect level based on the user's comfort level experienced during deceleration via braking. The set effect level may be a customer feature preference setting, which may disable anti-pitch mode operation or set the level of brake reduction to a level at or between fully OFF and fully ON. The set effect level may change during a braking event and/or from one braking event to a next braking event. The disclosed calibratable values and/or the set effect level may be set by a user providing and/or adjusting corresponding scalar values.

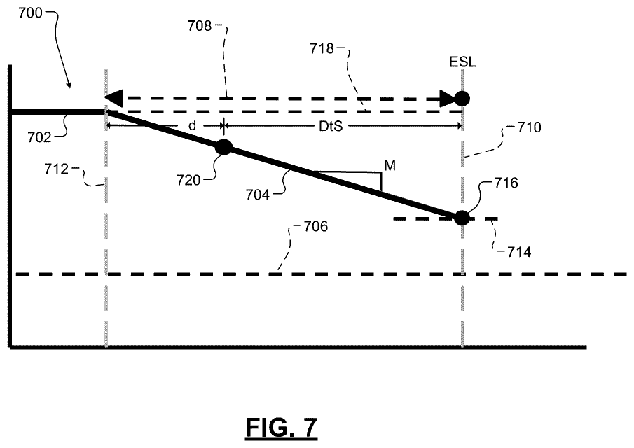

FIG. 7 shows a plot of brake torque requested versus distance illustrating reduced brake torque for a last period (or portion) of a braking event. A brake torque requested curve 700 is shown and includes a first line segment 702 and a second line segment 704. The first line segment 702 represents an incoming brake torque (IBT) requested. The second line segment 704 represents an adjusted brake torque (ABT) requested due to a reduced amount of brake torque requested. In an embodiment, the brake control module reduces brake torque to a minimum brake percentage (MBP) based on the slope of curve 704. The brake control module also maintains during braking at least a minimum amount of brake torque requested. This is represented by dashed line 706, which is a calibratable minimum threshold brake torque request (CmTBTR). The traveled distance from when brake torque starts being reduced until when the vehicle is stopped is called out by dashed line 708. The traveled distance to stop 708 may be a remaining stopping distance for the braking event. Dashed line 710 is indicative of a location where the vehicle is stopped. This may be referred to as the estimated (or expected) stopping location (ESL). Dashed line 712 is indicative of when brake torque request reduction begins and a calibratable and/or user set distance until vehicle is fully stopped. The location where brake torque reduction begins that is prior to when the vehicle is fully stopped is designated by dashed line 712. This location is a calibratable distance to when the vehicle is fully stopped CDFS (designated 708 in FIG. 7). The amount of brake torque requested when the vehicle is stopped is represented by dashed line 714 and point 716 represents the vehicle being stopped. The dashed line 718 represents brake torque requested if anti-pitch mode is disabled.

The example of FIG. 7 is applicable to when the vehicle speed is initially greater than or equal to 10 kph, a driver commanded brake torque via a brake actuator is greater than a minimum brake torque requested threshold (e.g., the threshold 706), and a vehicle estimated distance to stop is less than or equal to an expected predetermined distance to stop threshold. Referring to FIGS. 6-7, a distance d traveled after the point at which brake reduction begins (line segment 712) may be represented by equation 1, where DtS is a remaining distance until stopped. An example point 720 is shown indicating an example location of the vehicle after passing the point at which brake reduction begins.

d=CDFS−DtS (1)

The slope M of the line segment 702 may be represented by equation 2 and if ESL is 0 then equation 3.

M=(IBT−MBP)/(CDFS−ESL) (2)

M=(IBT−MBP)/(CDFS) (3)

The adjusted brake torque may be determined using, for example, equation 4.

ABT=IBT−(M−d) (4)

FIG. 8 shows a plot 800 of adjusted brake torque requested versus estimated distance to stop illustrating different brake torque reduction modes and corresponding percentages of brake torque reduction. As described above, the effect level may be selected and the amount of brake torque reduction may be determined based on the effect level selected. This information may be stored in memory 206 and/or memory of the EBCM 205. In the example of FIG. 8, three different brake torque reduction mode profiles are shown for three respective effect levels. The brake torque reduction mode profiles are represented by linear curve 802, and curves 804, 806. The curves 802, 804, 806 have respective effect levels of low, medium and high. Other profiles may be selected between the shown profiles and represented by the provided three-dimensional shape. These profiles and corresponding values are provided as examples, other profiles and corresponding values may be implemented.

The magnitude of brake pressure decrease during the last portion of a braking event and the rate of brake pressure decrease may be determined based on a distance to a nearest object forward of the vehicle. As similarly described above, if the object is within a nearby zone of the vehicle, anti-pitch mode is disabled and the brake pressure is not reduced. This may occur when an object is within an expected stopping range of the vehicle; is less than a predetermined distance from an expected stopping location of the vehicle; and/or are outside the expected stopping range by less than the predetermined distance. The closer the object, the less the brake requested torque and brake pressure are reduced. Thus, the amount of reduction is based on the relative location and speed of the object. The rate of brake torque decrease is a function of an initiation point of decrease and a magnitude of brake torque decrease. The rate of brake pressure decrease is also a function of an initiation point of decrease and a magnitude of pressure decrease.

FIGS. 7-8 are a couple of examples of how to determine the adjusted brake torque requested. Other methods may be used.

The initial torque decay or reduction in brake torque requested starts at 100% for each of the profiles in order to provide a smooth transition between brake torque levels and between pressure levels. The adjusted brake torque requested may be determined using a look-up table, which may be represented as a 3-D surface as shown in FIG. 8. Multiple profile options may be selected based on driver and/or occupant input, driving parameters, and/or vehicle parameters. The selection may be based on estimated stopping distance as shown, as well as other parameters, such as vehicle size, vehicle weight, vehicle speed, brake torque requested, brake pressure, typical driving behavior, etc. The adjusted brake torque requested does not drop below the CmTBTR, which in the example shown is 50%. Transitions between different levels of brake torque requested may be smooth in order to minimize driver unexpected feel.

The reduction of pitch rate by spreading the change of pitch over a last predetermined distance of a braking event prior to an at rest state provides pitch changes that result in a more comfortable braking event for vehicle occupants. The disclosed system allows for an occupant to turn ON and OFF anti-pitch mode operation and to adjust the amount of brake torque reduction for variable control to offer a selectable range of comfort braking during last portions of braking events.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCamI, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A brake torque control system of a host vehicle, the brake torque control system comprising:
a memory configured to store, for a braking event, a plurality of values indicative respectively of whether an object has been detected forward of the host vehicle, a speed of the host vehicle, and at least one of an expected stopping distance and an expected stopping location of the host vehicle; and
a brake control module configured to
based on the plurality of values, i) operate in an anti-pitch mode, and ii) reduce at least one of an amount of brake torque requested and a brake pressure applied for a last remaining portion of the braking event to reduce pitch of the host vehicle prior to coming to a complete stop, and
not reduce the at least one of the amount of brake torque requested and the brake pressure applied for a portion of the braking event prior to the last remaining portion of the braking event.

2. The brake torque control system of claim 1, wherein:
the brake control module is configured to reduce the at least one of the amount of brake torque requested and the brake pressure applied for a last predetermined distance of the braking event; and
the last predetermined distance is less than or equal to 2 meters.

3. The brake torque control system of claim 1, wherein:
the brake control module is configured to limit an amount of increased braking distance due to the reduction in the at least one of the amount of brake torque requested and the brake pressure applied; and
the amount of increased braking distance is limited to 0.2 meters.

4. The brake torque control system of claim 1, further comprising an object detection sensor configured to detect one or more objects forward of the host vehicle and generate an object detection signal indicative of a detected one or more objects forward of the host vehicle,
wherein the brake control module is configured to adjust an amount of the reduction in the at least one of the amount of brake torque requested and the brake pressure applied based on distances and speeds of the one or more objects relative to the host vehicle.

5. The brake torque control system of claim 1, wherein the brake control module is configured to disable the anti-pitch mode based on at least one of proximity and speed of an object relative to the host vehicle.

6. The brake torque control system of claim 1, further comprising a speed sensor configured to detect the speed of the host vehicle,
wherein the brake control module is configured to enable the anti-pitch mode when the speed is greater than a set threshold.

7. The brake torque control system of claim 1, further comprising a brake actuator sensor configured to detect whether brakes of the host vehicle are being applied,
wherein the brake control module is configured to disable the anti-pitch mode when the brakes are not applied.

8. The brake torque control system of claim 1, wherein the brake control module is configured to adjust the amount of brake torque requested based on: the expected stopping distance; the speed of the host vehicle; and a predetermined distance from when brake torque reduction is to begin to when the host vehicle is stopped.

9. The brake torque control system of claim 1, wherein the brake control module is configured to:
adjust the amount of brake torque requested based on a set effect level, the set effect level is preselected and ranges between 0 and 1;
multiply an amount of brake torque reduction by the set effect level to provide a resultant value; and
subtract the resultant value from the amount of brake torque requested to provide a resultant amount of brake torque requested.

10. The brake torque control system of claim 1, wherein the brake control module is configured to, based on the plurality of values, reduce a magnitude, adjust a duration and adjust a reduction rate of change in the at least one of the brake torque requested and the brake pressure applied.

11. The brake torque control system of claim 1, wherein the brake control module is configured to, based on the plurality of values and at least one of distance and speed of a detected object relative to the host vehicle, reduce a magnitude of the brake pressure, adjust a reduction rate of change in brake pressure, and adjust a reduction rate of change of the brake pressure based on.

12. A brake torque control method comprising:
storing, for a braking event, a plurality of values indicative respectively of whether an object has been detected forward of a host vehicle, a speed of the host vehicle, and at least one of an expected stopping distance and an expected stopping location of the host vehicle;
based on the plurality of values, operating in an anti-pitch mode and reducing at least one of an amount of brake torque requested and a brake pressure applied for a last remaining portion of the braking event to reduce pitch of the host vehicle prior to coming to a complete stop; and
refraining from reducing the at least one of the amount of brake torque requested and the brake pressure applied for a portion of the braking event prior to the last remaining portion of the braking event.

13. The brake torque control method of claim 12, further comprising:
detecting one or more objects forward of the host vehicle and generating an object detection signal indicative of a detected one or more objects forward of the host vehicle; and
adjusting an amount of the reduction in the at least one of the amount of brake torque requested and the brake pressure applied based on distances and speeds of the one or more objects relative to the host vehicle.

14. The brake torque control method of claim 12, further comprising disabling the anti-pitch mode based on at least one of proximity and speed of an object relative to the host vehicle.

15. The brake torque control method of claim 12, further comprising:
detecting the speed of the host vehicle; and
enabling the anti-pitch mode when the speed is greater than a set threshold.

16. The brake torque control method of claim 12, further comprising:
detecting whether brakes of the host vehicle are being applied; and
disabling the anti-pitch mode when the brakes are not applied.

17. The brake torque control method of claim 12, further comprising adjusting the amount of brake torque requested based on: the expected stopping distance; the speed of the host vehicle; and a predetermined distance from when brake torque reduction is to begin to when the host vehicle is stopped.

18. The brake torque control method of claim 12, further comprising:
adjusting the amount of brake torque requested based on a set effect level, the set effect level is preselected and ranges between 0 and 1;
multiplying an amount of brake torque reduction by the set effect level to provide a resultant value; and
subtracting the resultant value from the amount of brake torque requested to provide a resultant amount of brake torque requested.

19. The brake torque control method of claim 12, further comprising, based on the plurality of values, reducing at least one of a magnitude, a duration and a reduction rate of change in the brake torque requested.

20. The brake torque control method of claim 12, further comprising, based on the plurality of values and at least one of distance and speed of a detected object relative to the host vehicle, reducing a magnitude of the brake pressure and adjusting a reduction rate of change of the brake pressure.
